(19) United States
(12) Patent Application Publication
(10) Pub. No.: US 2020/0133176 A1
(43) Pub. Date: Apr. 30, 2020

(54) FIXING DEVICE AND IMAGE FORMING APPARATUS INCORPORATING SAME

(71) Applicant: Arinobu YOSHIURA, Kanagawa (JP)

(72) Inventor: Arinobu YOSHIURA, Kanagawa (JP)

(73) Assignee: Ricoh Company, Ltd., Tokyo (JP)

(21) Appl. No.: 16/584,160

(22) Filed: Sep. 26, 2019

(30) Foreign Application Priority Data
Oct. 29, 2018 (JP) 2018-202736

(51) Int. Cl. G03G 15/20

(52) U.S. Cl. CPC G03G 15/2053

(57) ABSTRACT

A fixing device includes a fixing rotator, a pressure rotator that contacts the fixing rotator, a heater that heats the fixing rotator, a nip formation pad, a slide aid, a support, a reflector, a light shield, and a belt holder. The nip formation pad contacts the pressure rotator via the fixing rotator to form a fixing nip between the fixing rotator and the pressure rotator. The slide aid, including a lubricant, is disposed between the fixing rotator and the nip formation pad. The support supports the nip formation pad. The reflector reflects radiation heat from the heater. The light shield intercepts the radiation heat. The belt holder holds the fixing rotator. In a direction parallel to an axis of the fixing rotator, the belt holder and a longitudinal end portion of the slide aid that is located to be shielded by the light shield are distanced from each other.

### CROSS-REFERENCE TO RELATED APPLICATION

This patent application is based on and claims priority pursuant to 35 U.S.C. § 119(a) to Japanese Patent Application No. 2018-202736, filed on Oct. 29, 2018, in the Japan Patent Office, the entire disclosure of which is hereby incorporated by reference herein.

### BACKGROUND

### Technical Field

Embodiments of the present disclosure generally relate to a fixing device and an image forming apparatus incorporating the fixing device, and more particularly, to a fixing device for fixing a toner image onto a recording medium, and an image forming apparatus for forming an image on a recording medium with the fixing device.

### Related Art

Various types of electrophotographic image forming apparatuses are known, including copiers, printers, facsimile machines, and multifunction machines having two or more of copying, printing, scanning, facsimile, plotter, and other capabilities. Such image forming apparatuses usually form an image on a recording medium according to image data. Specifically, in such image forming apparatuses, for example, a charger uniformly charges a surface of a photoconductor as an image bearer. An optical writer irradiates the surface of the photoconductor thus charged with a light beam to form an electrostatic latent image on the surface of the photoconductor according to the image data. A developing device supplies toner to the electrostatic latent image thus formed to render the electrostatic latent image visible as a toner image. The toner image is then transferred onto a recording medium either directly, or indirectly via an intermediate transfer belt. Finally, a fixing device applies heat and pressure to the recording medium bearing the toner image to fix the toner image onto the recording medium. Thus, an image is formed on the recording medium.

Such a fixing device typically includes a fixing rotator, such as a roller, a belt, and a film, and a pressure rotator, such as a roller and a belt, pressed against the fixing rotator. The fixing rotator and the pressure rotator apply heat and pressure to the recording medium, melting and fixing the toner image onto the recording medium while the recording medium is conveyed between the fixing rotator and the pressure rotator.

### SUMMARY

In one embodiment of the present disclosure, a novel fixing device includes a fixing rotator, a pressure rotator, a heater, a nip formation pad, a slide aid, a support, a reflector, a light shield, and a belt holder. The pressure rotator is configured to contact an outer circumferential surface of the fixing rotator. The fixing rotator and the pressure rotator are configured to be pressed against each other to form a fixing nip through which a recording medium bearing an unfixed toner image is conveyed while being sandwiched by the fixing rotator and the pressure rotator. The heater is disposed opposite an inner circumferential surface of the fixing rotator to heat the fixing rotator. The nip formation pad is disposed opposite the inner circumferential surface of the fixing rotator along a longitudinal direction of the pressure rotator to contact the pressure rotator via the fixing rotator to form the fixing nip between the fixing rotator and the pressure rotator. The slide aid is disposed between the fixing rotator and the nip formation pad. The slide aid includes a lubricant. The support is configured to support the nip formation pad. The reflector is configured to reflect radiation heat from the heater. The light shield is configured to intercept the radiation heat from the heater at least at opposed longitudinal end portions of the light shield. The belt holder is configured to hold the fixing rotator. The belt holder and a longitudinal end portion of the slide aid are distanced from each other in a direction parallel to an axis of the fixing rotator. The longitudinal end portion of the slide aid is located to be shielded by the light shield from the radiation heat from the heater, in the direction parallel to the axis of the fixing rotator.

Also described is a novel image forming apparatus incorporating the fixing device.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1 is a schematic view of a fixing device as a first example to which embodiments of the present disclosure are applicable;

FIG. 2 is a schematic view of a fixing device as a second example to which the embodiments of the present disclosure are applicable;

FIG. 3 is a schematic view of a fixing device as a third example to which the embodiments of the present disclosure are applicable;

FIG. 4A is a partial perspective view of the fixing device illustrated in FIG. 3, particularly illustrating a light shield situated at a non-shield position;

FIG. 4B is a partial perspective view of the fixing device illustrated in FIG. 3, particularly illustrating the light shield situated at a shield position;

FIG. 5A is a cross-sectional view of the fixing device illustrated in FIG. 4A;

FIG. 5B is a cross-sectional view of the fixing device illustrated in FIG. 5A;

FIG. 6 is a diagram of the light shield;

FIG. 7 is an exploded perspective view of a nip formation pad;

FIG. 8 is a schematic view of an image forming apparatus according to an embodiment of the present disclosure;

FIG. 9 is a cross-sectional view of a comparative fixing device; and

FIG. 10 is a cross-sectional view of a fixing device incorporated in the image forming apparatus of FIG. 8, according to an embodiment of the present disclosure.

The accompanying drawings are intended to depict embodiments of the present disclosure and should not be interpreted to limit the scope thereof. Also, identical or similar reference numerals designate identical or similar components throughout the several views.

### DETAILED DESCRIPTION

In describing embodiments illustrated in the drawings, specific terminology is employed for the sake of clarity. However, the disclosure of the present specification is not intended to be limited to the specific terminology so selected and it is to be understood that each specific element includes all technical equivalents that have a similar function, operate in a similar manner, and achieve a similar result.

Although the embodiments are described with technical limitations with reference to the attached drawings, such description is not intended to limit the scope of the disclosure and not all of the components or elements described in the embodiments of the present disclosure are indispensable to the present disclosure.

In a later-described comparative example, embodiment, and exemplary variation, for the sake of simplicity like reference numerals are given to identical or corresponding constituent elements such as parts and materials having the same functions, and redundant descriptions thereof are omitted unless otherwise required.

As used herein, the singular forms “a”, “an”, and “the” are intended to include the plural forms as well, unless the context clearly indicates otherwise.

It is to be noted that, in the following description, suffixes Y, C, M, and Bk denote colors of yellow, cyan, magenta, and black, respectively. To simplify the description, these suffixes are omitted unless necessary.

Referring to the drawings, wherein like reference numerals designate identical or corresponding parts throughout the several views, embodiments of the present disclosure are described below.

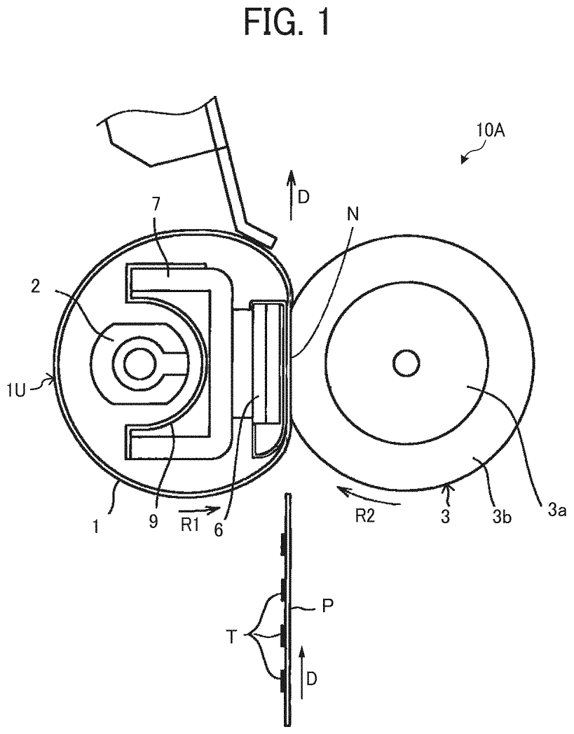

Initially with reference to FIGS. 1 to 3, a description is given of some fixing devices as examples to which the embodiments of the present disclosure are applicable.

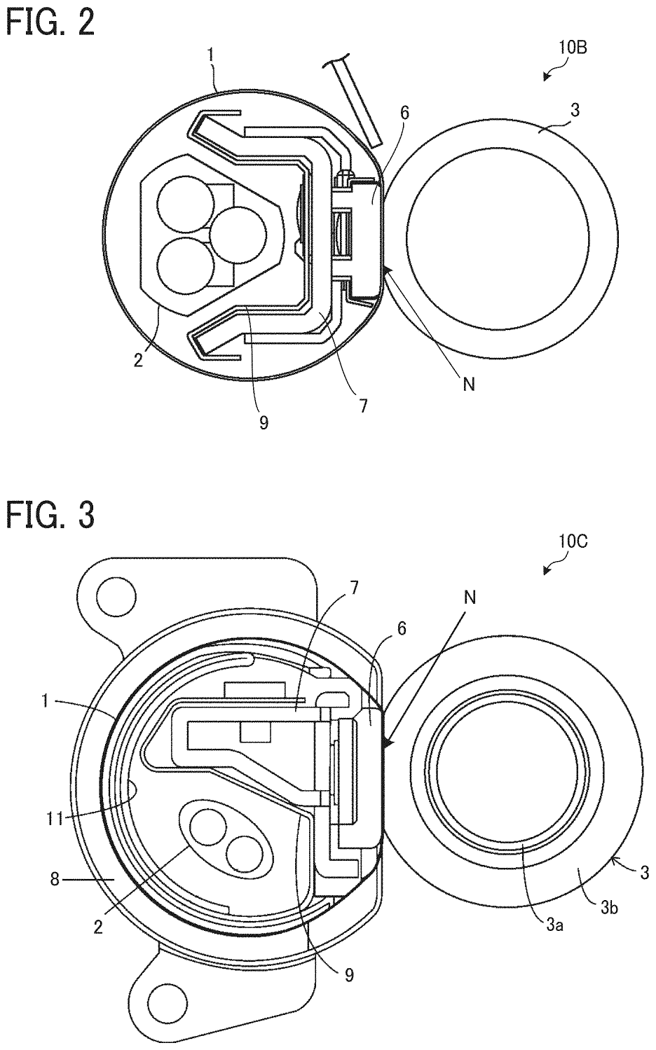

FIG. 1 is a schematic view of a fixing device 10A as a first example. FIG. 2 is a schematic view of a fixing device 10B as a second example. FIG. 3 is a schematic view of a fixing device 10C as a third example.

As illustrated in FIG. 1, the fixing device 10A includes a fixing belt 1 serving as a fixing rotator, a heater 2, a pressure roller 3 serving as a pressure rotator, a nip formation pad 6, a support 7, and a reflector 9. The fixing belt 1 is an endless belt rotatable in a direction indicated by arrow R1 (herein after referred to as a rotation direction R1). The heater 2 is disposed inside a loop formed by the fixing belt 1 to heat the fixing belt 1. In other words, the heater 2 is disposed opposite an inner circumferential surface of the fixing belt 1 to heat the fixing belt 1. Accordingly, the fixing belt 1 is directly heated by radiation heat from the heater 2, from an inner circumferential side of the fixing belt 1. The pressure roller 3 contacts an outer circumferential surface of the fixing belt 1 to form an area of contact, herein called a fixing nip N, between the fixing belt 1 and the pressure roller 3. A sheet P bearing an unfixed toner image T is conveyed through the fixing nip N while being sandwiched by the fixing belt 1 rotating in the rotation direction R1 and the pressure roller 3 rotating in a direction indicated by arrow R2 (hereinafter referred to as a rotation direction R2) as illustrated in FIG. 1. Note that the sheet P herein serves as a recording medium.

The nip formation pad 6 is disposed opposite the inner circumferential surface of the fixing belt 1, that is, inside the loop formed by the fixing belt 1, along a longitudinal direction of the pressure roller 3. The nip formation pad 6 contacts the pressure roller 3 via the fixing belt 1 to form the fixing nip N.

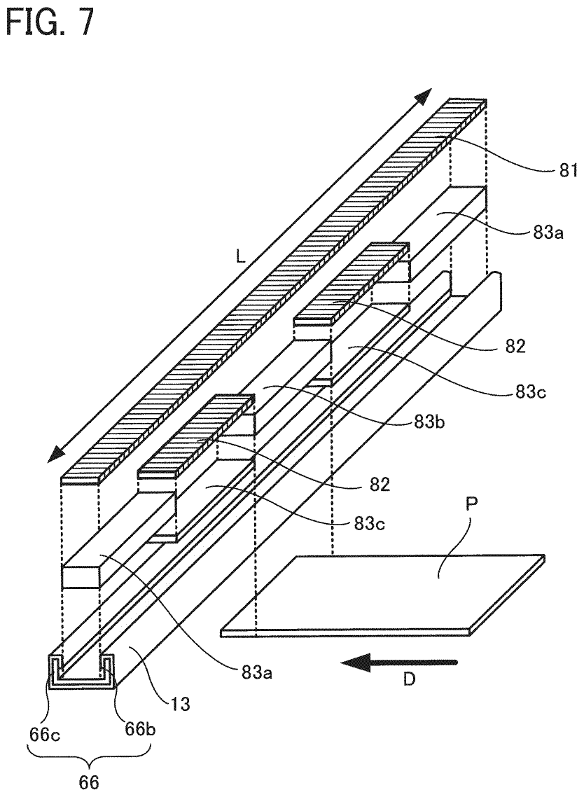

The support 7 supports the nip formation pad 6. The reflector 9 reflects the radiation heat from the heater 2. The fixing device 10A further includes a belt holder 8 and a light shield 11, as illustrated in FIG. 3. The belt holder 8 holds the fixing belt 1. The fixing device 10A further includes a slide sheet 13, serving as a slide aid, which is disposed between the fixing belt 1 and the nip formation pad 6 as illustrated in FIG. 7. The slide sheet 13 includes a lubricant.

The fixing belt 1 and the components disposed inside the loop formed by the fixing belt 1 constitute a belt unit 1U, which is detachably coupled to the pressure roller 3.

Although FIG. 1 illustrates the fixing nip N in a flat shape, the fixing nip N may be contoured into a recess or other shapes. One advantage of the fixing nip N defining the recess in the fixing belt 1 is that the recessed fixing nip N facilitates separation of the sheet P (i.e., recording medium) from the fixing belt 1 and reducing paper jam, because the recessed fixing nip N directs a leading end of the sheet P toward the pressure roller 3 when the sheet P is ejected from the fixing nip N.

The fixing belt 1 is an endless belt or film made of a metal material, such as nickel or stainless steel (e.g., steel use stainless or SUS), or a resin material such as polyimide. The fixing belt 1 is constructed of a base layer and a release layer. The release layer, as an outer surface layer of the fixing belt 1, is made of, e.g., perfluoroalkoxy alkane (PFA) or polytetrafluoroethylene (PTFE) to facilitate separation of toner contained in the toner image T on the sheet P from the fixing belt 1. Optionally, an elastic layer made of, e.g., silicone rubber may be interposed between the base layer and the release layer made of, e.g., PFA or PTFE of the fixing belt 1. In a case in which the fixing belt 1 does not incorporate the elastic layer made of, e.g., silicone rubber, the fixing belt 1 has a decreased thermal capacity that improves fixing property of being heated quickly to a desired fixing temperature at which the toner image T is fixed onto the sheet P. However, as the pressure roller 3 and the fixing belt 1 sandwich and press an unfixed toner image T onto the sheet P, slight surface asperities in the fixing belt 1 may be transferred onto the toner image T on the sheet P, resulting in variation in gloss of the solid toner image T that may appear as an orange peel image on the sheet P. The elastic layer is preferably provided to address such a situation, provided that the elastic layer made of, e.g., silicone rubber has a thickness not smaller than 100 μm. As the elastic layer made of, e.g., silicone rubber deforms, the elastic layer absorbs the slight surface asperities in the fixing belt 1, thereby preventing formation of the faulty orange peel image.

The support 7, such as a stay, is disposed inside the loop formed by the fixing belt 1 to support the nip formation pad 6. As the nip formation pad 6 receives pressure from the pressure roller 3, the support 7 prevents the nip formation pad 6 from being bent by such pressure. Accordingly, the fixing nip N is formed retaining an even width in an axial direction of the fixing belt 1. In other words, the fixing nip N retains an even length in a direction indicated by arrow D in FIG. 1 throughout an entire width of the fixing belt 1 in the axial direction of the fixing belt 1. Note that the direction indicated by arrow D is a direction in which the sheet P is conveyed, and hereinafter referred to as a sheet conveyance direction D. The support 7 is mounted on and secured to the belt holder 8 (e.g., flange) at each longitudinal end portion of the support 7, thus being positioned inside the fixing device 10A. Note that a longitudinal direction of the support 7 is parallel to the axial direction of the fixing belt 1. The reflector 9 is interposed between the heater 2 and the support 7, to reflect the radiation heat from the heater 2 toward the inner circumferential surface of the fixing belt 1. Thus, the reflector 9 prevents the support 7 from being heated by the heater 2 and reduces waste of energy. In a case in which the fixing device 10A excludes the reflector 9, a surface of the support 7 facing the heater 2 may be insulated or given a mirror finish to reflect the radiation heat from the heater 2 toward the inner circumferential surface of the fixing belt 1.

FIG. 1 illustrates a halogen heater as the heater 2. Alternatively, the heater 2 may be an induction heater (IH), a resistive heat generator, a carbon heater, or the like. As described below with reference to FIGS. 2 and 3, the number of the heater 2 (e.g., halogen heater) is not limited.

The pressure roller 3 is constructed of a core 3a, and an elastic layer 3b resting on the core 3a. A surface release layer, made of PFA or PTFE, rests on the elastic layer 3b to facilitate separation of the sheet P from the pressure roller 3.

A drive gear 12 is disposed on a longitudinal end portion of the pressure roller 3, for example, as illustrated in FIG. 10. A driver, such as a motor, is situated inside an image forming apparatus that includes the fixing device 10A. A driving force generated by the driver is transmitted to the pressure roller 3 through a gear train including the drive gear 12, thereby rotating the pressure roller 3.

A spring, for example, presses the pressure roller 3 against the nip formation pad 6 via the fixing belt 1. As the spring presses and deforms the elastic layer 3b of the pressure roller 3, the pressure roller 3 forms the fixing nip N having a given width, which is a given length in the sheet conveyance direction D.

The pressure roller 3 may be a hollow roller or a solid roller. In a case in which the pressure roller 3 is a hollow roller, a heater such as a halogen heater may be disposed inside the hollow roller. The elastic layer 3b may be made of solid rubber. Alternatively, in a case in which no heater is situated inside the pressure roller 3, the elastic layer 3b may be made of sponge rubber. The sponge rubber is preferable to the solid rubber because the sponge rubber has enhanced thermal insulation that draws less heat from the fixing belt 1.

The fixing belt 1 rotates in accordance with rotation of the pressure roller 3.

In the example illustrated in FIG. 1, as the driver drives and rotates the pressure roller 3, a driving force of the driver is transmitted from the pressure roller 3 to the fixing belt 1 at the fixing nip N, thereby rotating the fixing belt 1 by friction between the fixing belt 1 and the pressure roller 3. At the fixing nip N, the fixing belt 1 rotates while being sandwiched by the pressure roller 3 and the nip formation pad 6; whereas, at a circumferential span of the fixing belt 1 other than the fixing nip N, the fixing belt 1 rotates while each end portion of the fixing belt 1 in the axial direction of the fixing belt 1 is guided by the belt holder 8 (e.g., flange).

As illustrated in FIG. 1, the sheet P bearing the unfixed toner image T is conveyed in the sheet conveyance direction D while being guided by a guide plate. The sheet P enters the fixing nip N between the fixing belt 1 and the pressure roller 3 pressed against the fixing belt 1. The toner image T is fixed onto a surface of the sheet P under heat from the fixing belt 1 heated by the heater 2 and pressure exerted from the fixing belt 1 and the pressure roller 3.

With the configuration described above, the fixing device 10A attaining quick warm-up is manufactured at reduced costs.

Referring now to FIGS. 2 and 3, a description is given of fixing devices 10B and 10C as second and third examples, respectively, to which the embodiments of the present disclosure are applicable.

FIG. 2 is a schematic view of the fixing device 10B. FIG. 3 is a schematic view of the fixing device 10C.

The fixing device 10B illustrated in FIG. 2 is different from the fixing device 10A illustrated in FIG. 1 in the number of halogen heaters (i.e., heaters 2). Specifically, the fixing device 10A includes a single halogen heater as the heater 2. By contrast, the fixing device 10B includes three halogen heaters as the heaters 2. The three halogen heaters have different heat generation spans in the axial direction of the fixing belt 1 to cover different widths of recording media (e.g., sheets P). With the three halogen heaters that cover the different widths of recording media, the fixing device 10B reduces or eliminates redundant heating and enhances energy saving.

On the other hand, the fixing device 10C illustrated in FIG. 3 includes two halogen heaters as the heaters 2. FIG. 3 illustrates the light shield 11.

Referring now to FIGS. 4A to 6, a description is given of the light shield 11.

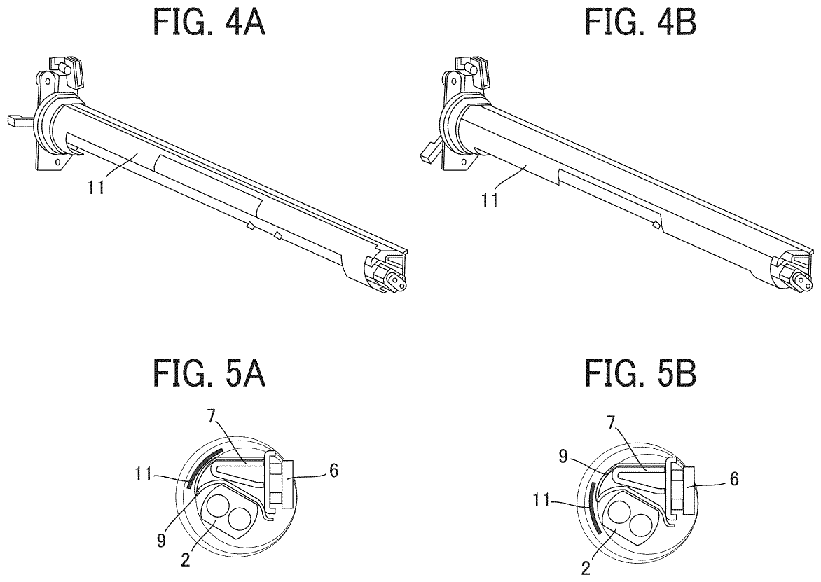

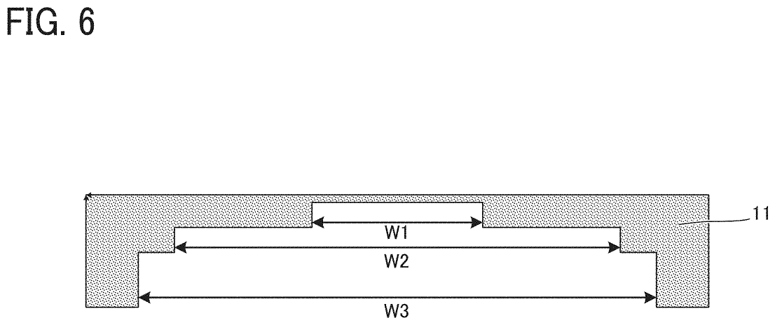

FIG. 4A is a partial perspective view of the fixing device 10C described above, particularly illustrating the light shield 11 situated at a non-shield position at which the light shield 11 does not shield the fixing belt 1 from the radiation heat from the heaters 2. FIG. 4B is a partial perspective view of the fixing device 10C described above, particularly illustrating the light shield 11 situated at a shield position at which the light shield 11 shields the fixing belt 1 from the radiation heat from the heaters 2. FIG. 5A is a cross-sectional view of the fixing device 10C illustrated in FIG. 4A. FIG. 5B is a cross-sectional view of the fixing device 10C illustrated in FIG. 5A. FIG. 6 is a diagram of the light shield 11.

As illustrated in FIG. 6, the light shield 11 has a shield area with a plurality of steps conforming to a plurality of widths (in this case, widths W1, W2, and W3) of recording media (e.g., sheets P) that can be conveyed through the fixing device 10C, for example. As illustrated in FIGS. 4A to 5B, the light shield 11 is pivotable along the inner circumferential surface of the fixing belt 1 without contacting the fixing belt 1. The light shield 11 is selectively pivoted to a plurality of shield positions according to the width of the sheet P conveyed through, e.g., the fixing device 10C, to shield an area of the fixing belt 1 such that the heaters 2 does not heat the area of the fixing belt 1. Accordingly, even when relatively small or narrow sheets P are conveyed through, e.g., the fixing device 10C continuously, the light shield 11 prevents a non-conveyance area of the fixing belt 1 from overheating. Note that the non-conveyance area of the fixing belt 1 is an area not in contact with the small sheets P while the small sheets P are conveyed through the fixing nip N. As a consequence, the light shield 11 prevents unproductive control of, e.g., the fixing device 10C for eliminating an overheated area of the fixing belt 1.

Referring now to FIG. 7, a description is given of the nip formation pad 6.

FIG. 7 is an exploded perspective view of the nip formation pad 6.

The nip formation pad 6 configured as illustrated in FIG. 7 reduces overheating of the non-conveyance area of the fixing belt 1. Specifically, the nip formation pad 6 reduces the number of halogen heaters as the heaters 2 while having a function as a substitute for the light shield 11. With the nip formation pad 6 illustrated in FIG. 7, the light shield 11 and a driver that drives the light shield 11 are removable from the fixing devices 10A, 10B, and 10C, allowing significant cost reduction.

Note that, in FIG. 7, L represents a light emission length of the heater 2; whereas D represents the sheet conveyance direction (i.e., sheet conveyance direction D).

As illustrated in FIG. 7, the nip formation pad 6 includes a thermal equalizer 66 serving as a primary heat transfer device. The slide sheet 13 is mounted on the thermal equalizer 66. As the fixing belt 1 rotates, the fixing belt 1 slides over the slide sheet 13 made of a low-friction material. The slide sheet 13 reduces a frictional load imposed to the fixing belt 1 and decreases a driving torque developed between the fixing belt 1 and the nip formation pad 6.

The thermal equalizer 66 is made of a material having an increased thermal conductivity, for example, copper. The thermal equalizer 66 extends in the axial direction of the fixing belt 1. That is, a longitudinal direction of the thermal equalizer 66 is parallel to the axial direction of the fixing belt 1. The thermal equalizer 66 absorbs excessive heat stored in the non-conveyance area of the fixing belt 1 and conducts the absorbed heat in the longitudinal direction of the thermal equalizer 66.

The thermal equalizer 66 includes bent portions as arms 66b and 66c. The arm 66b is disposed upstream from the arm 66c in the sheet conveyance direction D. The arm 66b has a sharp edge. While the fixing belt 1 rotates, the fixing belt 1 pulls the slide sheet 13 in a sliding direction, which is the rotation direction R1 of the fixing belt 1 illustrated in FIG. 1. However, the sharp edge of the arm 66b catches or engages the slide sheet 13, thereby solidly securing the slide sheet 13 to the nip formation pad 6. In a case in which the fixing belt 1 is configured to rotate in a reverse direction opposite the rotation direction R1, the arm 66c having a sharp edge is effective to catch and secure the slide sheet 13 to the nip formation pad 6.

As illustrated in FIG. 7, the nip formation pad 6 further includes primary thermal insulators 83a and 83b, a secondary thermal insulator 83c, a primary thermal absorber 81, and a secondary thermal absorber 82. The primary thermal insulator 83a is disposed at each longitudinal end portion of the nip formation pad 6. The primary thermal insulator 83b is disposed at a longitudinal center portion of the nip formation pad 6. The primary thermal insulators 83a and 83b are made of a material, such as resin, having a thermal conductivity smaller than a thermal conductivity of the thermal equalizer 66. The primary thermal insulators 83a and 83b prevent the primary thermal absorber 81 from excessively absorbing heat from the fixing belt 1. Accordingly, the fixing belt 1 is immune from a temperature decrease in a conveyance area of the fixing belt 1. Note that the conveyance area of the fixing belt 1 is an area in contact with the sheet P while the sheet P is conveyed through the fixing nip N. As a consequence, the primary thermal insulators 83a and 83b reduce fixing failures and energy consumption. In addition, the primary thermal insulators 83a and 83b shorten a warm-up time taken to warm up the fixing belt 1.

Like the primary thermal insulators 83a and 83b, the secondary thermal insulator 83c is made of, e.g., resin. The secondary thermal insulator 83c adjusts an amount of heat conducted from the thermal equalizer 66 to the primary thermal absorber 81 through the secondary thermal absorber 82. The thickness and length of the secondary thermal insulator 83c are adjusted based on the degree of overheating or a temperature increase of the non-conveyance area of the fixing belt 1.

Each of the primary thermal absorber 81 and the secondary thermal absorber 82 is made of a material having an increased thermal conductivity. The secondary thermal absorber 82 is disposed opposite the non-conveyance area of the fixing belt 1 that is susceptible to overheating or a temperature increase. Like the secondary thermal insulator 83c, the thickness and length of the secondary thermal absorber 82 are adjusted based on the degree of overheating or a temperature increase of the non-conveyance area of the fixing belt 1.

In some typical fixing devices, in order to prevent an increase in sliding load due to leakage of a lubricant over time, the volume and density of longitudinal end portions of a slide sheet are changed together with the amount of the lubricant applied, such that the slide sheet retains a greater amount of the lubricant at the longitudinal end portions than a longitudinal center portion of the slide sheet.

However, variation in errors such as pressure deviation in a texture direction and a longitudinal direction of the slide sheet may accelerate the leakage of the lubricant from an axial end portion of an endless belt (e.g., fixing belt), causing an increase in the sliding load (or torque) and fluctuations in a linear velocity of the endless belt (i.e., slip). As a consequence, a conveyance failure may occur.

To address such a situation, a fixing device 10 according to an embodiment of the present disclosure restrains such an increase in the sliding load and fluctuations in the linear velocity of the fixing belt 1, thereby preventing a conveyance failure. In addition, the fixing device 10 restrains an exposure of an edge of the nip formation pad 6, which is attributed to thermal contraction of the slide sheet 13, thereby preventing damage to the fixing belt 1.

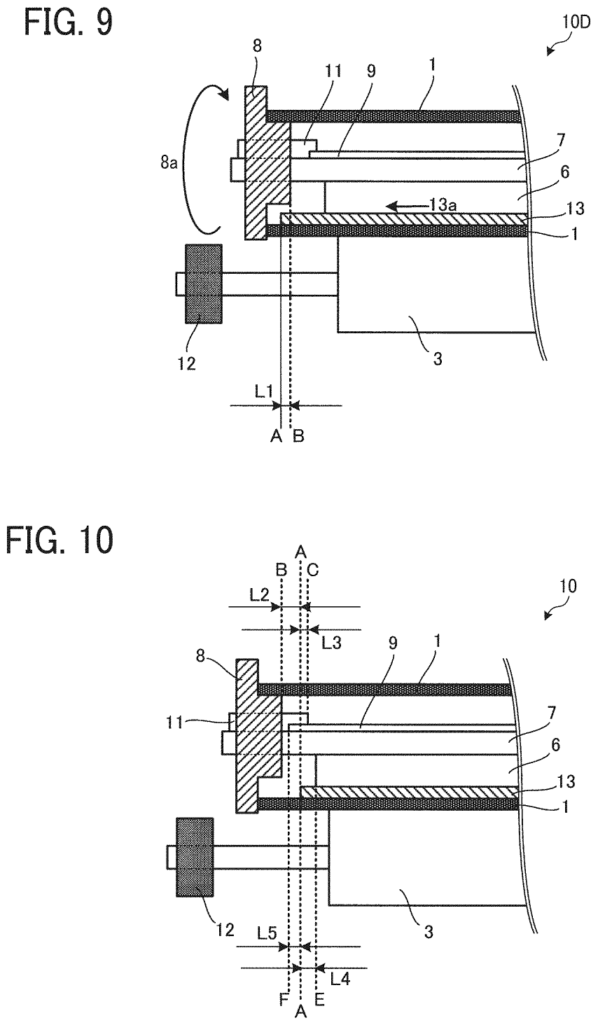

Referring now to FIGS. 9 and 10, a description is given of a comparative fixing device 10D and the fixing device 10 according to an embodiment of the present disclosure, respectively.

FIG. 9 is a cross-sectional view of the comparative fixing device 10D parallel to an axis of the fixing belt 1. FIG. 10 is a cross-sectional view of the fixing device 10 parallel to the axis of the fixing belt 1.

Initially with reference to FIG. 9, a description is now given of the comparative fixing device 10D.

In the cross section parallel to the axis of the fixing belt 1 in FIG. 9, a line A indicates a position of a longitudinal end portion of the slide sheet 13; whereas a line B indicates a position of an inner end face of the belt holder 8 in a longitudinal direction of the slide sheet 13. The longitudinal end portion of the slide sheet 13 is situated outward from the inner end face of the belt holder 8 in the longitudinal direction of the slide sheet 13, by a length represented by L1 in FIG. 9 (hereinafter referred to as a length L1).

Such a configuration moves a lubricant contained in the slide sheet 13 in a direction indicated by arrow 13a (hereinafter referred to as a moving direction 13a), thereby transferring the lubricant from the slide sheet 13 to the fixing belt 1. The lubricant is further transferred to the belt holder 8 when the fixing belt 1 rotates in a direction indicated by arrow 8a (hereinafter referred to as a rotation direction 8a) in FIG. 9. Thus, a lubricant channel is formed. Once the lubricant channel is formed, the lubricant continues to leak from the slide sheet 13.

To address such a situation, in the present embodiment, the longitudinal end portion of the slide sheet 13 is disposed inward from the inner end face of the belt holder 8 in the longitudinal direction of the slide sheet 13. Specifically, as illustrated in FIG. 10, the longitudinal end portion of the slide sheet 13 and the inner end face of the belt holder 8 in the longitudinal direction of the slide sheet 13 are distanced from each other by a given gap represented by L2 (hereinafter referred to as a gap L2) defined between the line A and the line B. Note that, as described above, the line A indicates the position of the longitudinal end portion of the slide sheet 13; whereas the line B indicates the position of the inner end face of the belt holder 8 in the longitudinal direction of the slide sheet 13.

Such a configuration allows a lubricant transferred from the slide sheet 13 to the fixing belt 1 to return to the slide sheet 13 when the fixing belt 1 rotates, thereby preventing formation of a lubricant channel through which the lubricant leaks from an axial end portion of the fixing belt 1.

In typical fixing devices, an area not shielded by a light shield absorbs radiation heat from a heater and reaches a relatively high temperature. When a heat-shrinkable slide sheet is disposed in such a high-temperature area, the slide sheet shrinks by heat in an increased amount. In other words, a heat-shrinking amount of the slide sheet increases. As a consequence, an edge of a nip formation pad may be revealed. Such a revealed edge of the nip formation pad may damage a fixing belt. To decrease the heat-shrinking amount of the slide sheet 13 and prevent damage to the fixing belt 1, in the present embodiment, the longitudinal end portion of the slide sheet 13 overlaps the light shield 11 by a length represented by L3 (hereinafter referred to as an overlapping length L3) defined between the line A and a line C in FIG. 10. As described above, the line A indicates the position of the longitudinal end portion of the slide sheet 13. On the other hand, the line C indicates a position of an inner end face of the light shield 11 in the longitudinal direction of the slide sheet 13.

In short, the longitudinal end portion of the slide sheet 13 is disposed overlapping the light shield 11 and inward from the inner end face of the belt holder 8 in the longitudinal direction of the slide sheet 13. Such a configuration prevents leakage of the lubricant from the axial end portion of the fixing belt 1, thereby reducing the sliding load (or torque) and restraining fluctuations in the linear velocity (i.e., fixing sleeve slip). Accordingly, a conveyance failure is prevented. In addition, the configuration described above reduces the heat-shrinking amount of the slide sheet 13, thereby preventing revealing of the edge of the nip formation pad 6 and damage to the fixing belt 1.

A description is now given of advantages of a fixing device (e.g., fixing device 10, 10A, 10B, or 10C) according to the embodiments described above. The fixing device includes a fixing rotator (e.g., fixing belt 1), a heater (e.g., heater 2), a pressure rotator (e.g., pressure roller 3), a nip formation pad (e.g., nip formation pad 6), a support (e.g., support 7), a belt holder (e.g., belt holder 8), a reflector (e.g., reflector 9), a light shield (e.g., light shield 11), and a slide aid (e.g., slide sheet 13). The fixing rotator is, e.g., an endless belt rotatable in a direction (e.g., rotation direction R1). The pressure rotator contacts an outer circumferential surface of the fixing rotator to form a fixing nip (e.g., fixing nip N) between the fixing rotator and the pressure rotator. A recording medium (e.g., sheet P) bearing an unfixed toner image (e.g., toner image T) is conveyed through the fixing nip N while being sandwiched by the fixing rotator and the pressure rotator. The heater is disposed opposite an inner circumferential surface of the fixing rotator to heat the fixing rotator. The nip formation pad is disposed opposite the inner circumferential surface of the fixing rotator along a longitudinal direction of the pressure rotator to contact the pressure rotator via the fixing rotator to form the fixing nip. The slide aid is disposed between the fixing rotator and the nip formation pad. The slide aid includes a lubricant. The support supports the nip formation pad. The reflector reflects radiation heat from the heater. The light shield intercepts the radiation heat from the heater at least at opposed longitudinal end portions of the light shield. The belt holder holds the fixing rotator. In a cross section or a direction parallel to an axis of the fixing rotator, the belt holder and a longitudinal end portion of the slide aid are distanced from each other by a gap (e.g., gap L2) while the longitudinal end portion of the slide aid is located to be shielded by the light shield from the radiation heat from the heater.

In addition, in the cross section or the direction parallel to the axis of the fixing rotator in the fixing device, the slide aid is preferably longer than the nip formation pad while the longitudinal end portion of the slide aid is preferably located outward from a longitudinal end portion of the nip formation pad. Such a configuration prevents revealing of an edge of the nip formation pad and damage to the fixing rotator.

Specifically, as illustrated in FIG. 10, the longitudinal end portion of the slide sheet 13 is located outward from a longitudinal end portion of the nip formation pad 6 by a length represented by L4 (hereinafter referred to as a length L4) defined between the line A and a line E. Note that, as described above, the line A indicates the position of the longitudinal end portion of the slide sheet 13. On the other hand, the line E indicates a position of the longitudinal end portion of the nip formation pad 6. Note that the length L4 is preferably 1 mm or longer in consideration of the heat-shrinking amount of the slide sheet 13 and variations in component dimensions.

As illustrated in FIGS. 9 and 10, the reflector 9 is disposed on a part of the support 7 that supports the nip formation pad 6, so as to reflect the radiation heat from the heater 2. However, the residual part of the support 7 is subjected to the radiation heat from the heater 2, reaching a relatively high temperature. If the slide sheet 13 is disposed on a high temperature area subjected to the radiation heat from the heater 2, the heat shrinkage of the slide sheet 13 increases to remarkably reveal the edge of the nip formation pad 6, resulting in damage to the fixing belt 1.

To address such a situation, in the cross section or the direction parallel to the axis of the fixing rotator in the fixing device according to the embodiments of the present disclosure, the slide aid is preferably shorter than the reflector while the longitudinal end portion of the slide aid is preferably located inward from a longitudinal end portion of the reflector.

Specifically, as illustrated in FIG. 10, the longitudinal end portion of the slide sheet 13 is distanced from a longitudinal end portion of the reflector 9 by a given gap represented by L5 (hereinafter referred to as a gap L5) defined between the line A and a line F. Note that, as described above, the line A indicates the position of the longitudinal end portion of the slide sheet 13. On the other hand, the line F indicates a position of the longitudinal end portion of the reflector 9.

In a case of one-side driving performed by the drive gear 12 alone, the rotation of the drive gear 12 generates a force that presses a drive-gear side of the pressure roller 3 toward the fixing nip N, resulting in load deviation in the longitudinal direction of the pressure roller 3. Note that the drive-gear side of the pressure roller 3 is one side of the pressure roller 3 provided with the drive gear 12. The load deviation causes the lubricant to flow from a larger load side to a smaller load side, resulting in a partial exhaustion of the lubricant in the longitudinal direction of the slide sheet 13. As a consequence, an increase in the sliding load (or torque) and the fluctuations in linear velocity (i.e., fixing sleeve slip) may cause a conveyance failure.

To address such a situation, in the cross section or direction parallel to the axis of the fixing rotator in the fixing device according to the embodiments of the present disclosure, a first length between a reference portion and the longitudinal end portion, as a first longitudinal end portion, of the slide aid is different from a second length between the reference portion and another longitudinal end portion, as a second longitudinal end portion, of the slide aid. More specifically, the first length is preferably greater than the second length. Note that the first longitudinal end portion of the slide aid is closer to a drive gear (e.g., drive gear 12) than the second longitudinal end portion of the slide aid is. The reference portion of the slide aid is located between the first longitudinal end portion of the slide aid and the second longitudinal end portion of the slide aid. The reference portion of the slide aid corresponds to a longitudinal center portion of the pressure rotator.

Specifically, as illustrated in FIG. 10, the slide sheet 13 (i.e., slide aid) is disposed such that the longitudinal end portion (i.e., first longitudinal end portion) of the slide sheet 13 is longer than another longitudinal end portion (i.e., second longitudinal end portion) of the slide sheet 13 from a reference portion located between the first longitudinal end portion of the slide sheet 13 and the second longitudinal end portion of the slide sheet 13. Note that the first longitudinal end portion of the slide sheet 13 is closer to the drive gear 12 than the second longitudinal end portion of the slide sheet 13 is. The reference portion of the slide sheet 13 corresponds to a longitudinal center portion of the pressure roller 3. The configuration described above addresses such a situation that the lubricant is likely to flow and exhaust at the first longitudinal end portion of the slide aid easier than the second longitudinal end portion of the slide aid. In short, the configuration described above increases an amount of the lubricant held at the first longitudinal end portion of the slide aid. As a consequence, the fixing device reduces the sliding load (or torque) and restrains fluctuations in linear velocity (i.e., fixing sleeve slip), thereby preventing a conveyance failure.

According to the examples and the embodiments described above, the fixing belt 1 serves as a fixing rotator; whereas the pressure roller 3 serves as a pressure rotator. Alternatively, a fixing film, a fixing sleeve, or the like may be used as a fixing rotator; whereas a pressure belt or the like may be used as a pressure rotator.

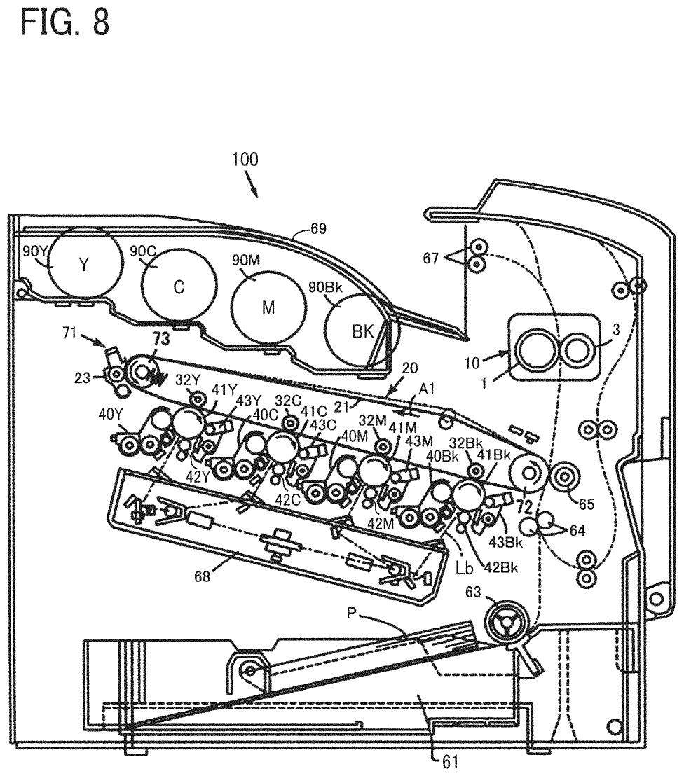

Referring now to FIG. 8, a description is given of an image forming apparatus 100, which includes the fixing device 10 described above, according to an embodiment of the present disclosure.

FIG. 8 is a schematic view of the image forming apparatus 100 as an electrophotographic printer.

Specifically, FIG. 8 illustrates the image forming apparatus 100 as a color printer employing a tandem system in which a plurality of image forming devices is aligned in a direction in which a transfer belt is stretched, to form toner images in different colors. The image forming apparatus 100 is not limited to such a color printer that employs the tandem system. Alternatively, the image forming apparatus 100 may be, e.g., a copier, a facsimile machine, or a multifunction peripheral (MFP) having at least two of printing, copying, scanning, facsimile, and plotter functions.

As illustrated in FIG. 8, the image forming apparatus 100 employs a tandem structure in which four drum-shaped photoconductors 41Y, 41C, 41M, and 41Bk are arranged side by side. The photoconductors 41Y, 41C, 41M, and 41Bk, serving as image bearers, are configured to form toner images of yellow, cyan, magenta, and black as separation colors, respectively. In the image forming apparatus 100 illustrated in FIG. 8, the toner images, as visible images, of yellow, cyan, magenta, and black formed on the photoconductors 41Y, 41C, 41M, and 41Bk, respectively, are primarily transferred onto a transfer belt 21 serving as an intermediate transferor. The transfer belt 21 is an endless belt disposed opposite the photoconductors 41Y, 41C, 41M, and 41Bk and rotatable in a direction indicated by arrow A1 (hereinafter referred to as a rotation direction A1). Specifically, in a primary transfer process, the yellow, cyan, magenta, and black toner images are superimposed one atop another on the transfer belt 21, thus being transferred from the photoconductors 41Y, 41C, 41M, and 41Bk, respectively, onto the transfer belt 21 that rotates in the rotation direction A1. Thereafter, in a secondary transfer process, the yellow, cyan, magenta, and black toner images are transferred together from the transfer belt 21 onto a sheet P serving as a recording medium. Thus, a composite color toner image is formed on the sheet P.

Each of the photoconductors 41Y, 41C, 41M, and 41Bk is surrounded by various pieces of equipment to form the yellow, cyan, magenta, and black toner images as the photoconductors 41Y, 41C, 41M, and 41Bk rotate. For example, the photoconductor 41Bk is surrounded by a charger 42Bk, a developing device 40Bk, a primary transfer roller 32Bk, and a cleaner 43Bk in this order in a direction in which the photoconductor 41Bk rotates. With such pieces of equipment, the black toner image is formed. Like the photoconductor 41Bk, the photoconductors 41Y, 41C, and 41M are surrounded by chargers 42Y, 42C, and 42M, developing devices 40Y, 40C, and 40M, primary transfer rollers 32Y, 32C, and 32M, and cleaners 43Y, 43C, and 43M in this order in a direction in which the photoconductors 41Y, 41C, and 41M rotate, respectively. After the charger 42Bk charges the photoconductor 41Bk, for example, an optical writing device 68 writes an electrostatic latent image on the photoconductor 41Bk.

As the transfer belt 21 rotates in the rotation direction A1, the yellow, cyan, magenta, and black toner images formed as visible images on the photoconductors 41Y, 41C, 41M, and 41Bk, respectively, are primarily transferred successively onto the transfer belt 21 such that the yellow, cyan, magenta, and black toner images are superimposed at the same position on the transfer belt 21. Specifically, the primary transfer rollers 32Y, 32C, 32M, and 32Bk disposed opposite the photoconductors 41Y, 41C, 41M, and 41Bk via the transfer belt 21, respectively, are supplied with electric voltage to transfer the yellow, cyan, magenta, and black toner images at different times onto the transfer belt 21 from the photoconductors 41Y, 41C, 41M, and 41Bk in this order. Note that the photoconductor 41Y is an upstream photoconductor and the photoconductor 41Bk is a downstream photoconductor in the rotation direction A1 of the transfer belt 21.

In other words, the photoconductors 41Y, 41C, 41M, and 41Bk are aligned in this order in the rotation direction A1 of the transfer belt 21. The photoconductors 41Y, 41C, 41M, and 41Bk are located in four image forming stations that form the yellow, cyan, magenta, and black toner images, respectively.

That is, the image forming apparatus 100 includes the four image forming stations that form the yellow, cyan, magenta, and black toner images, respectively. In addition, the image forming apparatus 100 includes a transfer belt unit 20, a secondary transfer roller 65, a transfer belt cleaner 23, and the optical writing device 68. The transfer belt unit 20 is situated above and opposite the photoconductors 41Y, 41C, 41M, and 41Bk. The transfer belt unit 20 includes the transfer belt 21 and the primary transfer rollers 32Y, 32C, 32M, and 32Bk. The secondary transfer roller 65, serving as a transferor, is disposed opposite the transfer belt 21 and rotated in accordance with rotation of the transfer belt 21. The transfer belt cleaner 23 is disposed opposite the transfer belt 21 to clean the surface of the transfer belt 21. The optical writing device 68 is disposed below and opposite the four image forming stations.

The optical writing device 68 includes, e.g., a semiconductor laser serving as a light source, a coupling lens, an fθ lens, a toroidal lens, a deflection mirror, and a rotatable polygon mirror serving as a deflector. The optical writing device 68 emits a laser beam Lb, corresponding to image data of each color of yellow, cyan, magenta, and black, to each of the photoconductors 41Y, 41C, 41M, and 41Bk. For example, as illustrated in FIG. 8, the optical writing device 68 emits the laser beam Lb to the photoconductor 41Bk. Thus, the optical writing device 68 writes or forms an electrostatic latent image on each of the photoconductors 41Y, 41C, 41M, and 41Bk.

The image forming apparatus 100 further includes a sheet feeding device 61 and a registration roller pair 64. The sheet feeding device 61 includes a sheet tray that loads a plurality of sheets P, which is conveyed one by one to an area of contact, herein called a secondary transfer nip, formed between the transfer belt 21 and the secondary transfer roller 65. Activation of the registration roller pair 64 is timed to feed a sheet P conveyed from the sheet feeding device 61 to the secondary transfer nip formed between the transfer belt 21 and the secondary transfer roller 65 such that the sheet P meets the yellow, cyan, magenta, and black toner images on the transfer belt 21 at the secondary transfer nip. The image forming apparatus 100 further includes a sensor to detect that a leading end of the sheet P reaches the registration roller pair 64.

The image forming apparatus 100 further includes the fixing device 10, a sheet ejection roller pair 67, an output tray 69, and toner bottles 90Y, 90C, 90M, and 90Bk. The fixing device 10, serving as a fusing unit employing a roller fixing system, fixes the composite color toner image onto the sheet P. The sheet ejection roller pair 67 ejects the sheet P bearing the fixed toner image outside a housing of the image forming apparatus 100. The output tray 69 is disposed atop the housing of the image forming apparatus 100. The sheet P is ejected onto the output tray 69 outside the housing of the image forming apparatus 100 by the sheet ejection roller pair 67. The toner bottles 90Y, 90C, 90M, and 90Bk are situated below the output tray 69. The toner bottles 90Y, 90C, 90M, and 90Bk are replenished with fresh toner of yellow, cyan, magenta, and black, respectively.

In addition to the transfer belt 21 and the primary transfer rollers 32Y, 32C, 32M, and 32Bk, the transfer belt unit 20 includes a driving roller 72 and a driven roller 73. The transfer belt 21 is entrained around the driving roller 72 and the driven roller 73.

A biasing member, such as a spring, biases the driven roller 73 against the transfer belt 21. With such a configuration, the driven roller 73 serves as a tension applicator that applies tension to the transfer belt 21. The transfer belt unit 20, the secondary transfer roller 65, and the transfer belt cleaner 23 together construct a transfer device 71.

The sheet feeding device 61 is disposed in a lower portion of the housing of the image forming apparatus 100. The sheet feeding device 61 includes a sheet feeding roller 63 that contacts an upper face of an uppermost sheet P of the plurality of sheets P loaded on the sheet tray of the sheet feeding device 61. As the sheet feeding roller 63 is rotated counterclockwise in FIG. 8, the sheet feeding roller 63 feeds the uppermost sheet P toward the registration roller pair 64.

The transfer belt cleaner 23 of the transfer device 71 includes a cleaning brush and a cleaning blade disposed so as to face and contact the transfer belt 21. With the cleaning brush and the cleaning blade, the transfer belt cleaner 23 scrapes a foreign substance such as residual toner particles off the transfer belt 21, thereby removing the foreign substance from the transfer belt 21. Thus, the transfer belt cleaner 23 cleans the transfer belt 21.

The transfer belt cleaner 23 further includes a waste toner conveyer that conveys and discards the residual toner particles removed from the transfer belt 21.

According to the embodiments described above, a fixing device restrains an increase in sliding load and fluctuations in linear velocity of a fixing rotator, thereby preventing a fixing failure. In addition, the fixing device restrains an exposure of an edge of a nip formation pad, which is attributed to thermal contraction of a slide aid, thereby preventing damage to the fixing rotator.

Although the present disclosure makes reference to specific embodiments, it is to be noted that the present disclosure is not limited to the details of the embodiments described above. Thus, various modifications and enhancements are possible in light of the above teachings, without departing from the scope of the present disclosure. It is therefore to be understood that the present disclosure may be practiced otherwise than as specifically described herein. For example, elements and/or features of different embodiments may be combined with each other and/or substituted for each other within the scope of the present disclosure. The number of constituent elements and their locations, shapes, and so forth are not limited to any of the structure for performing the methodology illustrated in the drawings.

What is claimed is:

1. A fixing device comprising:
a fixing rotator;
a pressure rotator configured to contact an outer circumferential surface of the fixing rotator,
the fixing rotator and the pressure rotator being configured to be pressed against each other to form a fixing nip through which a recording medium bearing an unfixed toner image is conveyed while being sandwiched by the fixing rotator and the pressure rotator;
a heater disposed opposite an inner circumferential surface of the fixing rotator to heat the fixing rotator;
a nip formation pad disposed opposite the inner circumferential surface of the fixing rotator along a longitudinal direction of the pressure rotator to contact the pressure rotator via the fixing rotator to form the fixing nip between the fixing rotator and the pressure rotator;
a slide aid disposed between the fixing rotator and the nip formation pad,
the slide aid including a lubricant;
a support configured to support the nip formation pad;
a reflector configured to reflect radiation heat from the heater;
a light shield configured to intercept the radiation heat from the heater at least at opposed longitudinal end portions of the light shield; and
a belt holder configured to hold the fixing rotator,
the belt holder and a longitudinal end portion of the slide aid being distanced from each other in a direction parallel to an axis of the fixing rotator,
the longitudinal end portion of the slide aid being located to be shielded by the light shield from the radiation heat from the heater, in the direction parallel to the axis of the fixing rotator.

2. The fixing device according to claim 1,
wherein the slide aid is longer than the nip formation pad in the direction parallel to the axis of the fixing rotator, and
wherein the longitudinal end portion of the slide aid is located outward from a longitudinal end portion of the nip formation pad in the direction parallel to the axis of the fixing rotator.

3. The fixing device according to claim 1,
wherein the slide aid is shorter than the reflector in the direction parallel to the axis of the fixing rotator, and
wherein the longitudinal end portion of the slide aid is located inward from a longitudinal end portion of the reflector in the direction parallel to the axis of the fixing rotator.

4. The fixing device according to claim 1, further comprising a drive gear on a longitudinal end portion of the pressure rotator,
wherein the longitudinal end portion of the slide aid is closer to the drive gear than another longitudinal end portion of the slide aid is,
wherein a reference portion of the slide aid is located between the longitudinal end portion of the slide aid and said another longitudinal end portion of the slide aid,
wherein the reference portion of the slide aid corresponds to a longitudinal center portion of the pressure rotator, and
wherein a length between the reference portion and the longitudinal end portion of the slide aid is greater than a length between the reference portion and said another longitudinal end portion of the slide aid in the direction parallel to the axis of the fixing rotator.

5. The fixing device according to claim 1,
wherein the fixing rotator is an endless belt.

6. An image forming apparatus comprising:
an image bearer configured to bear a toner image; and
the fixing device according to claim 1,
the fixing device being configured to fix the toner image onto a recording medium.
